(19) United States
(12) Patent Application Publication
(10) Pub. No.: US 2017/0217720 A1
(43) Pub. Date: Aug. 3, 2017

(54) PROTECTOR AND ASSEMBLY

(71) Applicant: Sumitomo Chemical Company, Limited, Tokyo (JP)

(72) Inventor: Yosuke TSUKUDA, Niihama-shi (JP)

(21) Appl. No.: 15/418,005

(22) Filed: Jan. 27, 2017

(30) Foreign Application Priority Data
Jan. 29, 2016 (JP) 2016-016005

(51) Int. Cl. B65H 75/14; H01M 2/16

(52) U.S. Cl. CPC B65H 75/14; H01M 2/1686; H01M 2/166; H01M 2/1653

(57) ABSTRACT

Provided is a protector which allows (i) a separator roll to be protected from a shake and (ii) an assembly to be easily put in and taken out from a box. The protector includes: a base part having (i) a first surface which is a main surface and (ii) a second surface; a support part provided on the first surface of the base part, the support part being for supporting a core member at one of ends of the core member; and at least one leg part provided on the second surface of the base part, a direction in which the at least one leg part extends being not parallel to the second surface of the base part.

This Nonprovisional application claims priority under 35 U.S.C. §119 on Patent Application No. 2016-016005 filed in Japan on Jan. 29, 2016, the entire contents of which are hereby incorporated by reference.

### TECHNICAL FIELD

The present invention relates to (i) a protector used to assemble an assembly including a separator roll which is obtained by winding a separator for a secondary battery and (ii) such an assembly.

### BACKGROUND ART

A lithium-ion secondary battery includes therein a positive electrode and a negative electrode which are separated by a porous separator. In production of lithium ion secondary batteries, a separator roll is used. The separator roll is obtained by winding such a separator around a core having a cylindrical shape. In a case where the separator roll is transported or stored, an assembly including the separator roll is assembled by causing a core member to be inserted through the core of the separator roll.

Patent Literature 1 discloses an assembly configured such that (i) a core member is inserted through respective cores of separator rolls and (ii) protectors for protecting the separator rolls are provided at respective both ends of the core member. Each of the protectors disclosed in Patent Literature 1 has a plurality of leg parts, which are protrusions, on an edge of an inward surface of the each of the protectors, which inward surface is located on a separator roll side while the each of the protectors is fitted to the core member. In a case where the protectors are stacked up, the plurality of leg ports of one of the protectors overlap the respective plurality of leg parts of the other one of the protectors.

According to Patent Literature 1, it is possible to compactly stack up the protectors.

### CITATION LIST

### Patent Literature

[Patent Literature 1]

Japanese Patent No. 5683078 (registered on Jan. 23, 2015)

### SUMMARY OF INVENTION

### Technical Problem

FIG. 17 is a view illustrating a configuration of an assembly 150 including the protectors of Patent Literature 1. As illustrated in FIG. 17, the assembly 150 is configured such that (it a core member 130 it provided no an to extend through axis holes of a plurality of separator rolls 140 and (ii) protectors 120 are provided at respective both ends of the core member 130.

As illustrated in FIG. 18, the assembly 150 is packed into a box 151 before being transported. The box 151 in which the assembly 150 is packed is then transported.

Note, here, that an outward surface of each of the protectors 120 is flat in whole. Therefore, a vibration which occurs during transportation is directly applied to the plurality of separator rolls 140 via the protectors 120. This causes a problem that the plurality of separator rolls 140 are likely to be damaged.

The fact that the outward surface of the each of the protectors 120 is flat in whole further causes the following problem. That is, in a case where an worker puts the assembly 150 in and out from the box 151, the worker's hand, holding the outward surface of the each of the protectors 120, is likely to come into contact with a side surface of the box 151. This makes it difficult to put the assembly 150 in the box 151 and take out the assembly 150 from the box 151.

The present invention has been made in view of the above problems, and an object of the present invention is to provide a protector which allows (i) a separator roll to be protected from a shake while an assembly, packed in a box, is being transported and (ii) the assembly to be easily put in and taken out from the box.

### Solution to Problem

In order to attain the above object, a protector in accordance with an aspect of the present invention is a protector including: a base part having a plate shape, the base part having (i) a first surface which is a main surface and (ii) a second surface which is another main surface and which is opposite to the first surface; a support part provided on the first surface of the base part, the support part being for supporting a core member at one of ends of the core member; and at least one leg part provided on the second surface of the base part, a direction in which the at least one leg part extends being not parallel to the second surface of the base part.

### Advantageous Effects of Invention

According to an aspect of the present invention, it is possible to obtain a protector which allows (i) a separator roll to be protected from a shake while an assembly, packed in a box, is being transported and (ii) the assembly to be easily put in and taken out from the box.

### BRIEF DESCRIPTION OF DRAWINGS

FIG. 1 is a schematic view illustrating a cross sectional configuration of a lithium-ion secondary battery.

FIG. 2 is a schematic view illustrating details of a configuration of the lithium-ion secondary battery illustrated in FIG. 1

FIG. 3 is a schematic view illustrating another configuration of the lithium-ion secondary battery illustrated in FIG. 1.

FIG. 4 is a schematic view illustrating a configuration of a slitting apparatus for slitting the separator.

FIG. 5 is a view illustrating a configuration of a cutting device included in the slitting apparatus illustrated in FIG. 4.

FIG. 6 is a view illustrating how an assembly in accordance with Embodiment 1 of the present invention is assembled.

FIG. 7 is a view illustrating a configuration of the assembly in accordance with Embodiment 1 of the present invention.

FIG. 8 is a view illustrating the assembly, in accordance with Embodiment 1 of the present invention, which is fastened with a fastening band.

FIG. 9 is a view illustrating the assembly, in accordance with Embodiment 1 of the present invention, which is packed in a box.

(a) of FIG. 10 is a plan view illustrating a configuration of the protector in accordance with Embodiment 1 of the present invention. (b) of FIG. 10 is a side view illustrating the configuration of the protector illustrated in (a) of FIG. 10. (c) of FIG. 10 is a perspective view illustrating the configuration of the protector illustrated in (a) of FIG. 10.

FIG. 11 is a view illustrating the assembly, in accordance with Embodiment 1 of the present invention, which is vertically placed.

FIG. 12 is a view illustrating protectors, in accordance with Embodiment 1 of the present invention, which are stacked up.

(a) of FIG. 13 is a side view illustrating a configuration of a protector in accordance with Embodiment 2 of the present invention. (b) of FIG. 13 is a perspective view illustrating the configuration of the protector illustrated in (a) of FIG. 13.

(a) of FIG. 14 is a side view illustrating a configuration of a protector in accordance with Embodiment 3 of the present invention. (b) of FIG. 14 is a perspective view illustrating the configuration of the protector illustrated in (a) of FIG. 14.

FIG. 15 is a view illustrating how an assembly in accordance with Embodiment 4 of the present invention is assembled.

FIG. 16 is a perspective view illustrating a configuration of the assembly in accordance with Embodiment 4 of the present invention.

FIG. 17 is a view illustrating a configuration of an assembly including conventional protectors.

FIG. 18 is a view illustrating the assembly, including the conventional protectors, which is packed in a box.

### DESCRIPTION OF EMBODIMENTS

### Embodiment 1

In regard to a separator for a battery (hereinafter, referred to as a battery separator) which separator is wound up into a separator roll that is protected by a protector in accordance with an embodiment of the present invention, the following description will first discusses (i) a lithium-ion secondary battery, (ii) a separator, (iii) a heat-resistant separator, (iv) a method of producing a separator (heat-resistant separator), (v) a slitting apparatus, and (vi) a cutting device, in order, each of which is a basic component of the present invention.

(Lithium-Ion Secondary Battery)

A nonaqueous electrolyte secondary battery, typified by a lithium-ion secondary battery, has a high energy density. Due to this fact, nonaqueous electrolyte secondary batteries are currently widely used as (i) batteries for use in devices such as personal computers, mobile phones, and mobile information terminals, (ii) batteries for use in moving bodies such as automobiles and airplanes, and (iii) stationary batteries contributing to stable power supply.

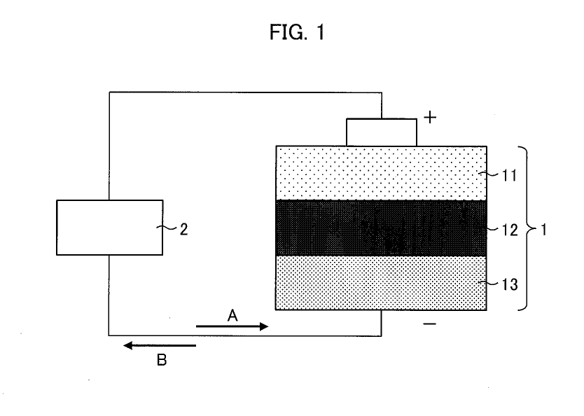

FIG. 1 is a schematic view illustrating a cross sectional configuration of a lithium-ion secondary battery 1. As illustrated in FIG. 1, the lithium-ion secondary battery 1 includes a cathode 11, a separator 12 (battery separator), and an anode 13. An external device 2 is provided outside the lithium-ion secondary battery 1 so as to be connected to the cathode 11 and the anode 13. This causes (i) electrons to move in a direction A while the lithium-ion secondary battery 1 is being charged and (ii) the electrons to move in a direction B while the lithium-ion secondary battery 1 is being discharged.

(Separator)

The separator 12 is provided so as to be sandwiched between the cathode 11, which is a positive electrode of the lithium-ion secondary battery 1, and the anode 13, which is a negative electrode of the lithium-ion secondary battery 1. The separator 12 is a porous film which causes the cathode 11 and the anode 13 to be separated and which allows lithium ions to move between the cathode 11 and the anode 13. Examples of a material of the separator 12 include polyolefin such as polyethylene and polypropylene.

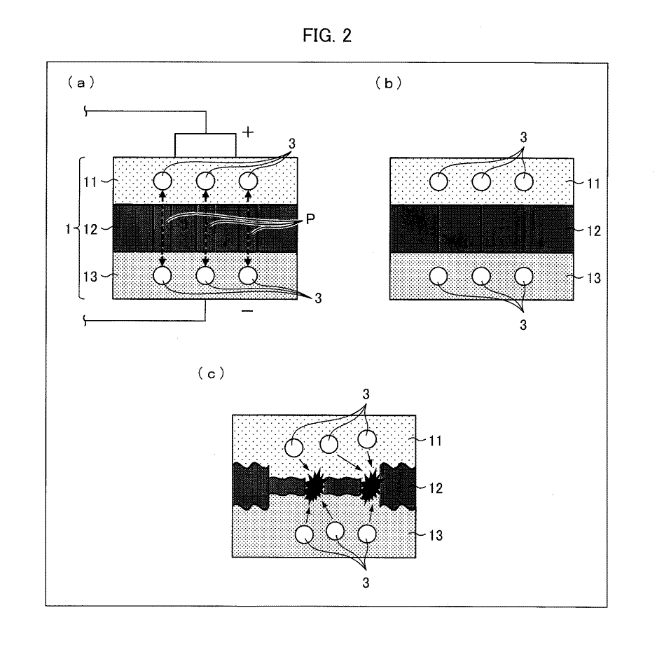

FIG. 2 is a schematic view illustrating details of a configuration of the lithium-ion secondary battery 1 illustrated in FIG. 1. (a) of FIG. 2 illustrates the configuration of the lithium-ion secondary battery 1 in a normal state. (b) of FIG. 2 illustrates a state in which a temperature of the lithium-ion secondary battery 1 has risen. (c) of FIG. 2 illustrates a state in which the temperature of the lithium-ion secondary battery 1 has sharply risen. As illustrated in (a) of FIG. 2, the separator 12 has many pores P. Normally, lithium ions 3 can move bock and forth in the lithium-ion secondary battery 1, through the pores P.

The temperature of the lithium-ion secondary battery 1 may rise due to, for example, excessive charging of the lithium-ion secondary battery 1 or a high current caused by short-circuiting of the external device. This causes the separator 12 to melt or soften, so that the pores P are closed as illustrated in (b) of FIG. 2. As a result, the separator 12 shrinks. This causes the lithium ions 3 to stop moving back and forth, and ultimately causes the temperature of the lithium-ion secondary battery 1 to stop rising.

Note, however, that in a case where the temperature of the lithium-ion secondary battery 1 sharply rises, the separator 12 suddenly shrinks. In this case, the separator 12 may be destroyed as illustrated in (c) of FIG. 2. This causes the lithium ions 3 to leak out from the separator 12 which has been destroyed. As a result, the lithium ions 3 will never stop moving back and forth. Consequently, the temperature continues to rise.

(Heat-Resistant Separator)

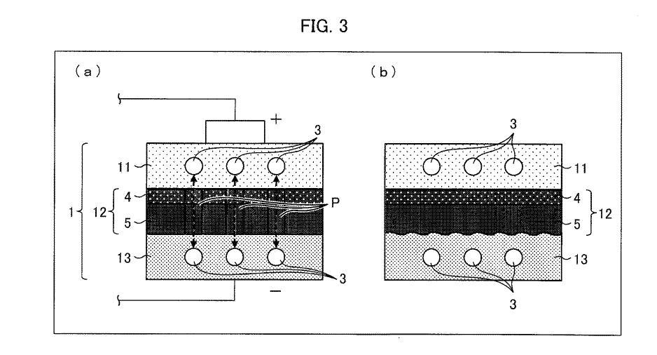

FIG. 3 is a schematic view illustrating another configuration of the lithium-ion secondary battery 1 illustrated in FIG. 1. (a) of FIG. 3 illustrates the configuration of the lithium-ion secondary battery 1 in a normal state. (b) of FIG. 3 illustrates a state in which the temperature of the lithium-ion secondary battery 1 has sharply risen. As illustrated in (a) of FIG. 3, the separator 12 can be a heat-resistant separator including a porous film 5 and a heat-resistant layer 4. The heat-resistant layer 4 is stacked on a surface of the porous film 5 which surface is located on a cathode 11 side. Note that the heal-resistant layer 4 can be alternatively stacked (i) on a surface of the porous film 5 which surface is located on an anode 13 side or (ii) on both surfaces of the porous film 5. The heat-resistant layer 4 also has pores which are similar to the pores P. Normally, the lithium ions 3 move back and forth through (i) the pores P and (ii) the pores of the heat-resistant layer 4. Examples of a material of the heat-resistant layer 4 include wholly aromatic polyamide (aramid resin).

Even in a case where the porous film 5 melts or softens due to a sharp rise in temperature of the lithium-ion secondary battery 1, a shape of the porous film 5 is maintained (see (b) of FIG. 3) because the heat-resistant layer 4 supports the porous film 5. This causes the porous film 5 to come off with melting or softening. Therefore, the pores P are only closed. This causes the lithium ions 3 to stop moving back and forth, and ultimately causes the above-described excessive discharging or excessive charging to stop. In this way, the separator 12 is prevented from being destroyed.

(Step of Producing Separator (Heat-Resistant Separator))

How to produce the separator (heat-resistant separator) of the lithium-ion secondary battery 1 is not specifically limited. The separator (heat-resistant separator) can be produced by a publicly known method. The following discussion assumes a case where the porous film 5 contains polyethylene as a main material. Note, however, that, even in a case where the porous film 5 contains another material, the separator 12 (heat-resistant separator) can be produced by employing a similar production method.

For example, the separator 12 can be produced by a method including the steps of (i) forming a film by adding an inorganic filler or a plasticizer to a thermoplastic resin and then (ii) removing the inorganic filler or the plasticizer by means of an appropriate solvent. In a case whore the porous film 5 is, for example, a polyolefin separator made of a polyethylene resin containing ultra-high molecular weight polyethylene, the separator 12 can be produced by the following method.

This method includes the steps of (1) kneading ultra-high molecular weight polyethylene with an inorganic filler (such as calcium carbonate or silica) or a plasticizer (such as low molecular weight polyolefin or fluid paraffin) to obtain a polyethylene resin composition (kneading step), (2) rolling the polyethylene resin composition to form a film (rolling step), (3) removing the inorganic filler or the plasticizer from the film obtained in the step (2) (removal step), and (4) stretching the film obtained in the step (3) to obtain the porous film 5 (stretching step). The step (4) can be alternatively carried out between the steps (2) and (3).

In the removal step, many fine pores are formed in the film. The fine pores of the film stretched in the stretching step serve as the above-described pores P. The porous film 5 (separator 12 including no heat-resistant layer) is thus obtained. Note that the porous film 5 is a polyethylene microporous film having a proscribed thickness and a prescribed air permeability.

Note that, in the kneading step, (i) 100 parts by weight of the ultra-high molecular weight polyethylene, (ii) 5 parts by weight to 200 parts by weight of low molecular weight polyolefin having a weight-average molecular weight of not more than 10,000, and (iii) 100 parts by weight to 400 parts by weight of the inorganic filler can be kneaded.

Thereafter, in a coating step, the heat-resistant layer 4 is formed on the porous film 5. For example, by applying, onto the porous film 5, an aramid/NMP (N-methyl-pyrrolidone) solution (coating solution), the heat-resistant layer 4 that is an aramid heat-resistant layer is formed. The heat-resistant layer 4 can be formed on a single surface or both surfaces of the porous film 5. Alternatively, the heat-resistant layer 4 can be formed on the porous film 5, by coating the porous film 5 with a mixed solution containing a filler such as alumina/carboxymethyl cellulose.

Note that, in the coating step, an adhesive layer can be formed on the porous film 5 by (i) applying a polyvinylidene fluoride/dimethyl acetamide solution (coating solution) to the porous film 5 (applying step) and (ii) solidifying the polyvinylidene fluoride/dimethylacetamide solution (solidifying step). The adhesive layer can be farmed on a single surface or both surfaces of the porous film 5.

A method of coating the porous film 5 with a coating solution is not specifically limited, provided that uniform wet coating can be carried out by the method. The method can be a conventionally publicly known method such as a capillary coating method, a spin coating method, a slit die coating method, a spray coating method, a dip coating method, a roll coating method, a screen printing method, a flexo printing method, a bar coaler method, a gravure coater method, or a die coater method. The heat-resistant layer 4 has a thickness which can be controlled by adjusting a thickness of a coating wet film or by adjusting a solid-content concentration in the coating solution.

It is possible to use a resin film, a metal belt, a drum, or the like as a support with which the porous film 5 is fixed or transferred in coating.

It is thus possible to produce the separator 12 (heat-resistant separator) in which the heat-resistant layer 4 is stacked on the porous film 5. The separator thus produced is wound around a core having a cylindrical shape. Note that a subject to be produced by the above production method is not limited to the heat-resistant separator. The above production method does not necessarily include the coating step. In a case where the coating step is not included in the method, the subject to be produced is the separator including no heat-resistant layer. Alternatively, an adhesive separator including other functional layer (such as later-described adhesive layer), instead of the heat-resistant layer, can be produced by a production method similar to that of the heat-resistant separator.

(Slitting Apparatus)

The heat-resistant separator or the separator including no heat-resistant layer (hereinafter, referred to as “separator”) preferably has a width (hereinafter, referred to as “product width”) suitable for an application product such as the lithium-ion secondary battery 1. Note, however, that the separator is produced so as to have a width that is equal to or larger than the product width, in view of an improvement in productivity. After the separator is once produced, the separator is cut (slit) into a separator(s) having the product width.

Note that “a width of a separator” means a length of the separator in a direction substantially perpendicular to a lengthwise direction and a thicknesswise direction of the separator. Hereinafter, a wide separator, which has not been subjected to slitting, is referred to as an “original sheet” or a “separator original sheet,” whereas particularly a separator which has been subjected to slitting is referred to as a “slit separator.” Note also that (i) “slitting” means to slit a separator in a lengthwise direction (direction in which a film is caused to flow during production; machine direction (MD)) and (ii) “cutting” means to cut the separator in a transverse direction (TD). Note that “a transverse direction (TD)” means a direction which is substantially perpendicular to a lengthwise direction (machine direction (MD)) and a thicknesswise direction of a separator.

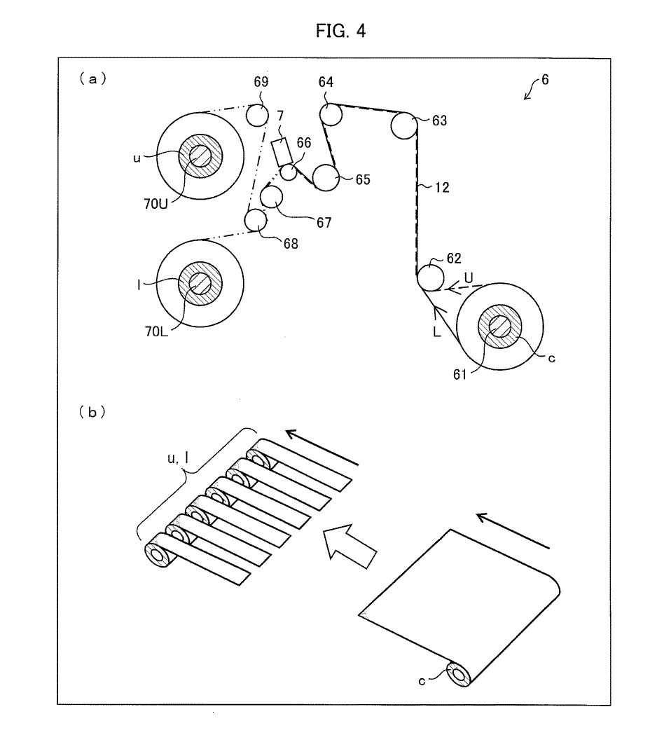

FIG. 4 is a schematic view illustrating a configuration of a slitting apparatus 6 for slitting a separator. (a) of FIG. 4 illustrates the entire configuration, and (b) of FIG. 4 illustrates arrangements before and after slitting the original sheet. As illustrated in (a) of FIG. 4, the slitting apparatus 6 includes a wind-off roller 61, rollers 62 through 69, and take-up rollers 70U and 70L. Each of the wind-off roller 61, the rollers 62 through 69, and the take-up rollers 70U and 70L is rotatably-supported, and has a cylindrical shape. The slitting apparatus 6 further includes cutting devices 7 (later described).

(Before Slitting)

In the slitting apparatus 6, a core c which has a cylindrical shape and around which the original sheet is wound is fitted on the wind-off roller 61. As illustrated in (b) of FIG. 4, the original sheet is wound off from the core c to a route U or L. The original sheet which has been thus wound off is transferred to the roller 68, via the rollers 63 through 67. While the original sheet is being transferred, the original sheet is slit into a plurality of slit separators. Note that the roller 67 is not necessarily provided. In such a case, the original sheet is transferred from the roller 66 to the roller 68.

(After Splitting (Step of Producing Separator Roll))

In a step of producing a separator roll (separator roll producing step), some of the plurality of slit separator are wound around respective cores u (bobbins) each of which has a cylindrical shape and each of which is fitted on the take-up roller 70U (see (b) of FIG. 4). Meanwhile, the others of the plurality of slit separators are wound around respective cores 1 (bobbins) each of which has a cylindrical shape and each of which is fined on the take-up roller 70L. Note that (i) a slit separator wound up in a roll and (ii) a core u, 1 are, as a whole, referred to as a “roll.” Separator rolls, configured such that the plurality of slit separators are wound around the respective cores u and 1, are thus produced.

(Cutting Device)

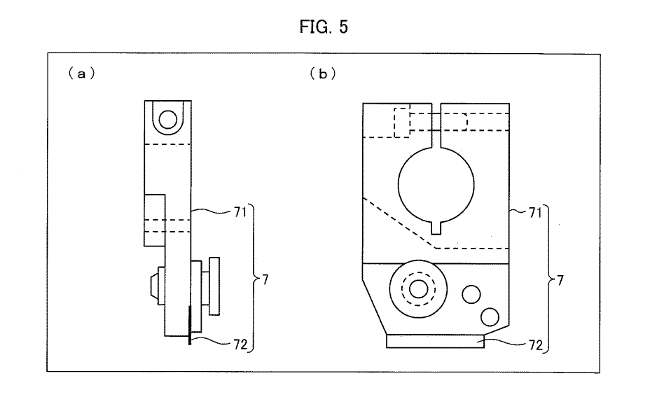

FIG. 5 is a view illustrating a configuration of a cutting device 7 included in the slitting apparatus 6 illustrated in (a) of FIG. 4. (a) of FIG. 5 is a side view of the cutting device 7, and (b) of FIG. 5 is a front view of the cutting device 7. As illustrated in (a) and (b) of FIG. 5, the cutting device 7 includes a holder 71 and a blade 72. The holder 71 is fixed to a housing or the like provided in the slitting apparatus 6. The holder 71 holds the blade 72 such that a separator original sheet being transferred and the blade 72 have a fixed positional relation. The blade 72 (i) has a finely sharpened edge and (ii) slits the separator original sheet by using the edge.

(Step of Assembling Assembly)

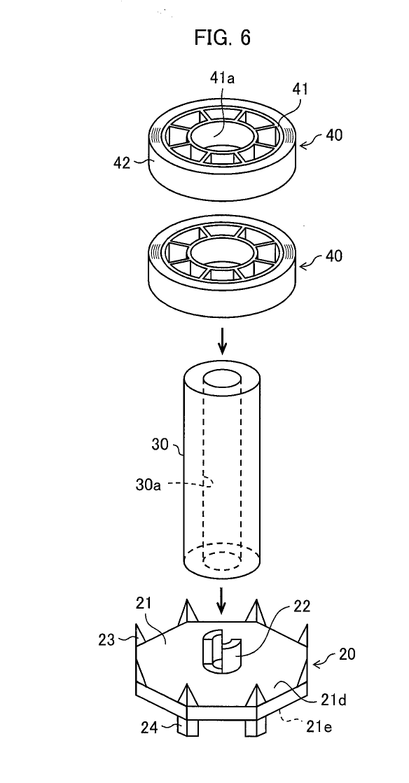

FIG. 6 is a view illustrating how an assembly in accordance with Embodiment 1 of the present invention is assembled. A separator roll 40 illustrated in FIG. 6 includes a core 41 and a separator 42 wound around the core 41. The separator roll 40 is a separator roll produced through the separator roll producing step (see (b) of FIG. 4). After a plurality of separator rolls 40 are produced, an assembly is produced, in a step of assembling an assembly (assembly step), so as to move or store the plurality or separator rolls 40 thus produced.

The core 41 corresponds to a core u, 1 illustrated in (b) of FIG. 4. The core 41 has, in its center, an axis hole 41a through which a core member 30, having a tubular shape, is inserted. The core 41 is preferably made of a resin such as an ABS resin, a polyethylene resin, a polypropylene resin, a polystyrene resin, or a vinyl chloride resin. The core 41 is preferably not made of metal, paper, or a fluorine resin.

The separator 42 corresponds to, not the original sheet, but a slit separator wound around the core u, 1 illustrated in FIG. 4. The separator 42 has a width (length in a vertical direction of FIG. 6) which is equal to or narrower than a width (length in the vertical direction of FIG. 6) of the core 41.

A protector 20 includes (i) a base part 21 having a first surface 21d and a second surface 21e which is opposite to the first surface 21d, (ii) a support part 22 provided on the first surface 21d, and (iii) leg parts 24, which are protrusions, provided on the second surface 21e. In the assembly step, the protector 20 is first placed on, for example, a floor so that the first surface 21d faces upward and the second surface 21e faces downward. Note that the protector 20 will be later described in detail with reference FIG. 10.

Then, the core member 30 is fitted to the protector 20 so that the support part 22 of the protector 20 is inserted, from one of ends of the core member 30, in a through hole 30a of the core member 30. Note that the through hole 30a extends inside the core member 30 in a direction in which the core member 30 extends. The core member 30 is thus fitted with the protector 20 at the one of the ends of the core member 30.

Next, the separator roll 40 is placed on the protector 20 so that the core member 30 is inserted, from the other one (that is, an upper end) of the ends of the core member 30, through the axis hole 41a of the separator roll 40. In this way, the core member 30 is inserted through respective axis holes 41a of separator rolls 40. This causes the separator rolls 40 to be stacked on the protector 20. Note that a buffer member can be provided between adjacent ones of the separator rolls 40. In this case, the adjacent ones of the separator rolls 40 and the buffer member are alternately stacked up.

After a given number of separator rolls 40 are stacked up, another protector 20 is fitted to the other one of the ends of the core member 30 so that a support part 22 of the another protector 20 is inserted in the through hole 30a of the care member 30.

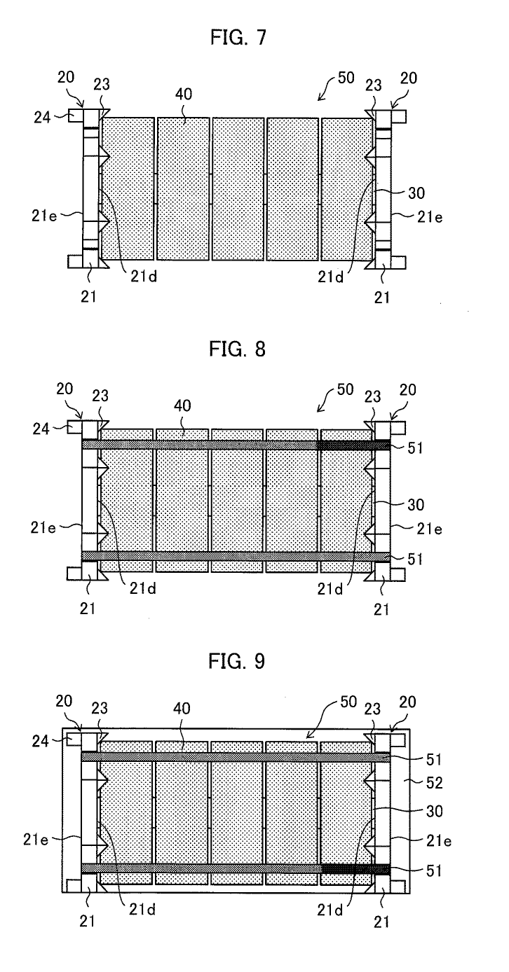

FIG. 7 is a view illustrating a configuration of an assembly 50. The assembly 50 is produced by (i) causing a core member 30 to be inserted through a given number of separator rolls 40 and (ii) fitting two protectors 20 to respective ends of the core member 30.

A first surface 21d of a base part 21 of each of the two protectors 20 is a surface (inward surface) closer to the separator rolls 40 through which the core member 30 is inserted. Meanwhile, a second surface 21e of the base part 21 of the each of the two protectors 20 is a surface (outward surface) farther from the separator rolls 40 through which the core member 30 is inserted.

FIG. 8 is a view illustrating the assembly SO which is fastened with use of a fastening band 51. After the assembly 50 is assembled in the assembly step, the assembly 50 is fastened in a subsequent fastening step. The fastening step involves winding the fastening band 51, which is a belt-shaped member, around the assembly 50 so that the fastening band 51 makes one or more rounds. This causes the two protectors 20, provided to the respective ends of the core member 30, and the separator rolls 40, provided between the two protectors 20, to be fastened with the fastening band 51. Example of the fastening band 51 includes a PP band, which is made of a polypropylene (PP) resin, and a stretch film.

In particular, the stretch film is thin and, therefore, can be easily broken manually without use of any tool such as scissors. The use of the stretch Him thus allows the assembly 50 to be easily disassembled, and also allows the separator rolls 40, through which the core member 30 is inserted, to be easily removed.

Furthermore, the stretch film, which is stretchable, is deformed in correspondence with a shape of each of the two protectors 20, in a case where the stretch film is wound around the assembly 50. The stretch film thus deformed is in contact with the two protectors 20. Therefore, it is not necessary to provide each of the two protectors 20 with a depression, such as an indented groove, which causes a position of the fastening band 51 to be retained.

Note that, before or after the assembly 50 is fastened with the fastening band 51, the assembly 50 may be covered in its entirely with, for example, a thin film. This allows the assembly 50 to be protected from adhesion of a foreign matter.

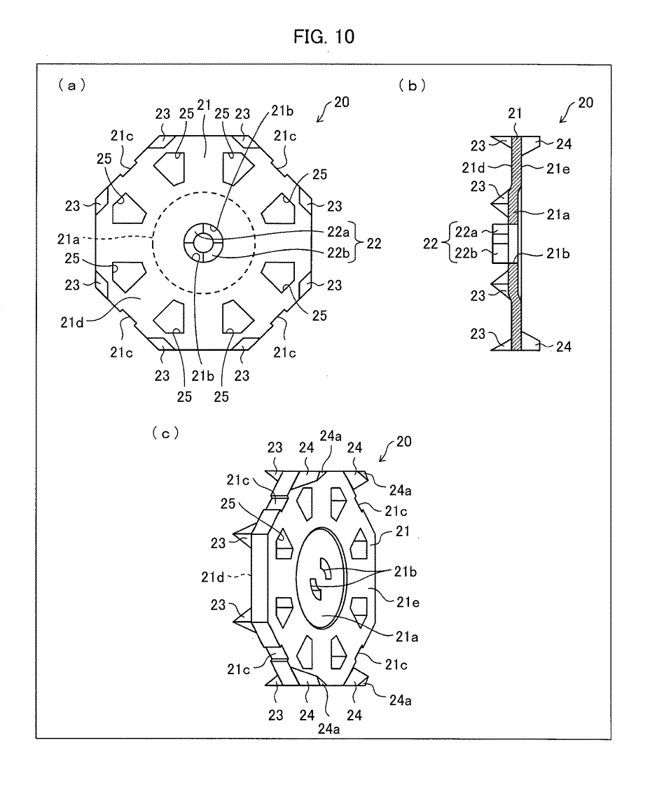

FIG. 9 is a view illustrating the assembly 50 which is packed in a box 52. After the assembly 50 is fastened with use of the fastening band 51 in the fastening step, the assembly 50 is packed into the box 52 in a packing step. The assembly 50 can be packed into the box 52 by a robot or a worker.

The packing step involves a robot arm holding or a worker manually holding respective second surfaces 21e (outward surfaces) of the two protectors 20 and packing the assembly 50 into the box 52. The assembly 50 is stored or transported while being packed in the box 52.

Each of the two protectors 20 included in the assembly 50 includes leg parts 24 (protrusions) provided on a corresponding one of the second surfaces 21e (outward surface). The leg parts 24 allow the assembly 50 to (i) be protected from a shake while the assembly 50 packed in the box 52 is being transported and (ii) be easily put in and taken out from the box 52. Effects brought about by the leg parts 24 will be later described in detail, when a configuration of the protector 20 is described.

(Configuration of Protector 20)

(a) of FIG. 10 is a plan view illustrating a configuration of a protector 20 in accordance with Embodiment 1 of the present invention. (b) of FIG. 10 is a side view illustrating the configuration of the protector 20. (c) of FIG. 10 is a perspective view illustrating the configuration of the protector 20.

The protector 20 is a protective member configured to protect separator rolls 40 through which a core member 30 is inserted and which are supported by the core member 30, from damage during storage or transport.

The protector 20 may be made of any material, provided that the any material allows the core member 30, which supports a given weight (that is, the total weight of the separator rolls 40 through which the core member 30 is inserted), to be suspended by two protectors 20. The material is, for example, a hard resin. The protector 20 may be mode of a material containing a resin such as an ABS resin, a polyethylene resin, a polypropylene resin, a polystyrene resin, and a vinyl chloride resin, or may be made of paper.

The protector 20 includes (i) a base part 21 having a plate shape, (ii) a support part 22 provided at the center of the base part 21, (iii) a plurality of projections 23 provided on a first surface 21d of the base part 21, and (iv) leg parts 24 provided on a second surface 21e of the base part 21.

The base part 21 has a bulge 21a, through holes 21b, indentations 21c, and openings 25.

The base part 21 is larger in diameter (area) than each of the separator rolls 40. Therefore, in a case where an assembly 50 including the two protectors 20 is horizontally placed on a floor, that is, placed an a floor so that a direction in which the assembly 50 extends (extending direction) is parallel to the floor, the separator rolls 40 of the assembly 50 are hung in midair by the core member 30 so as to be apart from the floor. This makes it possible to prevent the separator rolls 40 from being damaged due to, for example, rubbing against the floor.

Furthermore, even in a case where an external force is applied to the assembly 50 in the extending direction, it is possible to protect, from the external force, an entire end surface of one of the separator rolls 40 which one is adjacent to a corresponding one of the two protectors 20 (which end surface is a surface facing the corresponding one of the two protectors 20).

The base part 21 is in the form of a plate having a shape of a substantial regular polygon or a substantial circle. In Embodiment 1, the base part 21 of each of the two protectors 20 has a shape of a regular octagon. The fact that the base part 21 of each of the two protectors 20 has a shape of a regular polygon causes the assembly 50 including the two protectors 20 not to easily roll over even in a case where the assembly 50 is placed on the floor so that the extending direction of the assembly 50 is parallel to the floor (direction illustrated in FIG. 7). This allows the assembly 50 to be easily handled.

In a case where (i) the base part 21 has a shape of a regular octagon and (ii) the assembly 50 is placed so that the extending direction of the assembly 50 is parallel to the floor, a downward surface, which is in contact with the floor, and an upward surface, which is opposite to the downward surface, of the base part 21 are each parallel to the floor. This allows assemblies 50 to be easily stacked up.

Furthermore, in a case where (i) the base part 21 has a shape of a regular octagon and (ii) the assembly 50 is placed so that the extending direction of the assembly 50 is parallel to the floor, the octagonal base part 21 has two sides perpendicular to the floor. This allows assemblies 50 to be arranged in parallel to each other with no gap therebetween such that each protector 20 of each assembly 50 has a side perpendicular to the floor which side is in contact with a side of an adjacent protector 20 which side is perpendicular to the floor. It is therefore possible to efficiently arrange the assemblies 50. This advantage is achievable also in a case where the base part 21 has a shape of a regular rectangle.

The bulge 21a is present at the center of the base part 21 and a central portion of the base part 21 which central portion is a region surrounding the center. The bulge 21a sticks out from a peripheral portion of the base part 21.

In a case where the protector 20 is fitted to the core member 30, the bulge 21a is in contact with the core 41 of a corresponding one of the separator rolls 40 through which the core member 30 is inserted. Meanwhile, a portion of the base part 21 which portion surrounds the bulge 21a is not in contact with the separator 42 of the corresponding one of the separator rolls 40 through which the core member 30 is inserted.

The bulge 21a thus functions as a stopper which causes the base part 21 and the separator 42 to be apart from each other in a case where the protector 20 is fitted to the core member 30. This allows the separator 42 to be prevented from being damaged or bent due to contact with the protector 20.

The through holes 21b are positioned around the center of the base part 21. The through holes 21b are so shaped that in a case where protectors 20 are stacked up, the support part 22 of a lower one of the protectors 20 is inserted in the through holes 21b of an upper one of the protectors 20. The base part 21 having the through holes 21b allows protectors 20 to be stored in a stocked manner without being bulky.

The through holes 21b serve the following purpose as well: In a case where the assembly 50 is packed in the box 52 or taken out from the box 52, a worker places fingers or a robot places a robot arm in the through holes 21b so as to hold the assembly 50. The through holes 21b which are provided so as to, on the second surface 21e, be closer to the center than the leg parts 24 are as described above allows for a good balance. Thin in turn allows the assembly 50 to be easily and stably put in and taken out from the box 52.

The indentations 21c are each an indentation on which the fastening band 51 (see FIG. 8) is hooked so as to be wound around the assembly 50. The indentations 21c are each a depression and formed in a side surface of the base part 21. The indentations 21c have point symmetry with respect to the center of the base part 21. By hooking the fastening band 51 on the indentations 21c, it is possible to prevent the fastening band 51 from being displaced while, for example, the assembly 50 is being transported.

The openings 25 are provided in the base part 21. Note that the base part 21 may alternatively have only one opening 25. Providing the openings 25 in the base part 21 allows the protector 20 to be lighter in weight. Providing the openings 25 also allows a reduction in amount of a resin used. It is therefore possible to produce the protector 20 inexpensively. Note that the number of the openings 25 and a shape of each of the openings 25 are not limited to any particular number or shape.

The support part 22 protrudes from the first surface 21d of the base part 21. The support part 22 includes support parts 22a and 22b positioned in symmetry with respect to the center of the base part 21. The through holes 21b are provided between the support part 22a and the support part 22b. In other words, the support part 22a, a first through hole 21b, the support part 22b, and a second through hole 21b are arranged in this order in a circular pattern.

The support part 22 thus protrudes from the first surface 21d. By being fitted into one of the ends of the core member 30, the support part 22 supports the core member 30. This causes the support part 22 not to easily come off the core member 30 while the assembly 50 is being transported.

The projections 23 are each positioned at an edge of the first surface 21d of the base part 21. In Embodiment 1, the projections 23 are positioned at respective vertices of the regular octagon. Providing the projections 23 at the edge of the first surface 21d brings about the following advantage. That is, it is assumed that assemblies 50 are horizontally stacked up, that is, stacked up such that (i) an extending direction of each of the assemblies 50 is parallel to a floor and (ii) upward surfaces of two protectors 20 of a lower one of the assemblies 50 are in contact with downward surfaces of two protectors 20 of an upper one of the assemblies 50. In this case, it is possible to prevent two protectors 20 of any one of the assemblies 50 from coming into contact with a separator 42 of a separator roll 40 of another one of the assemblies 50, even in a case where the any one of the assemblies 50 is slightly displaced. This allows the separator 42 of the assembly 50 to be prevented from being damaged.

The projections 23 are each wedge-shaped, and are positioned at the respective vertices of the regular octagon. Thus, as illustrated in (c) of FIG. 10, in a case where a side of the octagonal protector 20 has been brought into contact with a floor surface, two of the projections 23 support the base part 21 to allow the protector 20 to stand alone. The projections 23 may have any of various shapes such as a cone shape or pillar shape other than a wedge shape.

The leg parts 24 each protrude from the second surface 21e of the base part 21. The leg parts 24 are each positioned at an edge of the second surface 21e of the base part 21. In Embodiment 1, the leg parts 24 are positioned at four of the vertices of the regular octagon, respectively. Note that the number of the leg parts 24 is not limited to four, but may be fewer than four or more than four.

A direction in which each of the leg parts 24 extends (extending direction) is not parallel to the second surface 21e of the base part 21. In Embodiment 1, each of the leg parts 24 extends in a direction perpendicular to the second surface 21e of the base part 21. In other words, each of the leg parts 24 does not extend along the second surface 21e of the base part 21, but are raised so as to protrude from the second surface 21e of the base part 21.

Therefore, in a case where a worker uses his/her hand or a robot uses a robot arm to hold the second surface 21e of the base part 21 (that is, an outer surface of the assembly 50) so as to put the assembly 50 in or take the assembly 50 out from the box 52 (see FIG. 9), the worker can insert his/her hand or the robot can insert the robot arm between the leg parts 24 so as to hold a central portion of the second surface 21e. It is thus possible to prevent the leg parts 24 from blocking the hand or robot arm. This ultimately allows the worker or the robot to easily hold the second surface 21e of the base part 21 and thus to easily put the assembly 50 in or take the assembly 50 out from the box 52. This makes it possible to efficiently put the assembly 50 in or take the assembly 50 out from the box 52.

Note that the extending direction of each of the leg parts 24 only needs not to be parallel to the second surface 21e of the base part 21. The leg parts 24 can be inclined against the second surface 21e of the base part 21.

The worker or the robot may alternatively hold any of the leg ports 24 so as to put the assembly 50 in or take the assembly SO out from the box 52. The worker or the robot can easily hold the any of the leg parts 24 because the leg parts 24 are apart from one another and each extend in a direction that is not parallel to the second surface 21e.

The leg parts 24 are, as illustrated in (c) of FIG. 10, each provided at the edge of the second surface 21e. Thus, as illustrated in (c) of FIG. 10, in the case where a side of the octagonal protector 20 has been brought into contact with the floor surface, two of the leg parts 24 support the base part 21 together with two of the projections 23 to allow the protector 20 to stand alone stably.

In Embodiment 1, the leg parts 24 are wedge-shaped. Two projections 23 on a side of the protector 20 have respective outer surfaces that form a flat surface together with (i) the corresponding side surface of the base part 21 and (ii) the respective outer surfaces of the corresponding leg parts 24. This configuration allows the protector 20 to stand alone more stably. The leg parts 24 may have any of various shapes such as a cone shape or pillar shape other than a wedge shape.

The leg parts 24 have respective heads 24a which form a plane substantially parallel to the first surface 21d of the base part 21. The respective heads 24a of the leg parts 24 each have a flat surface. The leg parts 24 are positioned in symmetry with respect to the center of the base part 21.

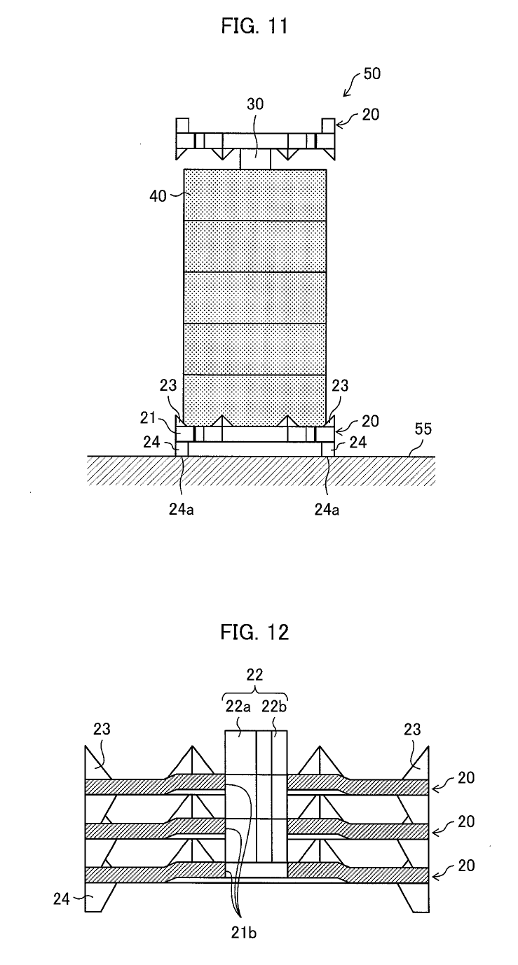

FIG. 11 is a view illustrating the assembly 50 which is vertically placed. Note that vertically placing the assembly 50 means placing the assembly 50 such that the extending direction of the assembly 50 is perpendicular to a floor 55.

The assembly 50 is vertically placed, for example, white the assembly 50 is still being assembled as described with reference to FIG. 6, while the assembly 50 is being stored, or when a separator roll 40 is removed from the assembly 50. In so doing, the leg parts 24 of one of the two projectors 20, which leg parts 24 are in contact with the floor 55. are positioned in symmetry with respect to the center of the one of the two protectors 20. This allows the assembly 50 to be vertically placed stably.

The respective heads 24a of the leg parts 24 form a plane substantially parallel to the first surface 21d of the base part 21. Furthermore, the respective heads 24a of the leg parts 24 each have a flat surface. This allows the assembly 50 to be vertically placed more stably.

Note that the respective heads 24a of the leg parts 24 may alternatively each have a pointed surface instead of a flat surface. Even in a case where the heads 24a each have a pointed surface instead of a flat surface, it is possible to vertically place the assembly 50 stably, provided that the heads 24a form a plane substantially parallel to the first surface 21d of the base part 21. Note, however, that, in a case where the heads 24a each have a flat surface, it is possible to vertically place the assembly 50 more stably because an area of contact between the leg parts 24 and the floor is larger, as compared with a case where the heads 24a each have a pointed surface.

It is only necessary that the respective heads 24a of ones of the leg parts 24, the number of which ones is necessary for the assembly 50 to be vertically placed, form a plane substantially parallel to the first surface 21d of the base part 21. Note that the protector 20 can include a short leg part 24 which is short to an extent that a head 24a of the short leg part 24 is not included in the plane formed by the respective heads 24a of the leg parts 24 (plane substantially parallel to the first surface 21d of the base part 21).

FIG. 12 is a view illustrating protectors 20 which are stacked up. As illustrated in FIG. 12, the protectors 20 are stacked up while being stored. As has been described, the protector 20 has, around the center of the base part 21, the through holes 21b in which the support parts 22a and 22b of another protector 20 are inserted. Therefore, in a case where the protectors 20 are stacked up, it is possible to insert support parts 22a and 22b of a lower one of the protectors 20 in respective through holes 21b of an upper one of the protectors 20. This allows the protectors 20 to be stored in a stacked manner without being bulky. It is therefore possible to save space necessary to store the protectors 20.

Note that the base part 21 can have, on the second surface 21e, depressions to which, in a case where the protectors 20 are stacked up, the respective projections 23 of a lower one of the protectors 20 are fitted (not illustrated). This allows the protectors 20 not to be bulky in a case where the projectors 20 are stacked up.

### Embodiment 2

The following description will discuss Embodiment 2 of the present invention with reference FIG. 13. For convenience of explanation, any member of Embodiment 2 that is identical in function to a corresponding member described for Embodiment 1 is assigned a common reference numeral, and a description thereof is omitted.

(a) of FIG. 13 is a side view illustrating a configuration of a protector 20A in accordance with Embodiment 2 of the present invention. (b) of FIG. 13 is a perspective view illustrating the configuration of the protector 20A.

The protector 20A is different from the protector 20 in that the protector 20A includes leg parts 24A provided at respective positions different from those of the leg parts 24 of the protector 20. In the other points, the protector 20A is similar to the protector 20.

The leg parts 24A of the protector 20A are provided on a second surface 21e of a base part 21, as with the case of the protector 20.

The leg parts 24A are not provided at an edge of the second surface 21e of the base part 21, but provided on a center side of the edge of the second surface 21e of the base part 21. Such a protector 20A also allows an assembly to (i) be protected from a shake while the assembly packed in a box is being transported and (ii) be easily put in and taken out from the box.

Note that the protector 20A is similar to the protector 20 in that (i) the leg parts 24A have respective heads 24Aa which form a plane substantially parallel to a first surface 21d of the base part 21, (ii) the respective heads 24Aa of the leg parts 24A each have a flat surface, and (iii) the leg parts 24A are provided in symmetry with respect to the center of the second surface 21e (for example, four leg parts 24A are provided). Furthermore, the protector 20A is similar to the protector 20 in that through holes 21b are provided so as to, on the second surface 21b, be closer to the center than the leg parts 24A are.

### Embodiment 3

The following description will discuss Embodiment 3 of the present invention with reference to FIG. 14. Note that, for convenience of explanation, any member of Embodiment 3 that is identical in function to a corresponding member described for Embodiment 1 or 2 is assigned a common reference numeral, and a description thereof is omitted.

(a) of FIG. 14 is a side view illustrating a configuration of a protector 20B in accordance with Embodiment 3 of the present invention. (b) of FIG. 14 is a perspective view illustrating the configuration of the protector 20B.

The protector 20B is different from the protector 20 in that the protector 20B includes (i) leg parts 24B provided at respective positions different from those of the leg parts 24 of the protector 20 and (ii) projections 23B inclined more outward than the projections 23. In other points, the protector 200 is similar to the protector 20.

The leg parts 24B of the protector 20B are provided on a second surface 21e of a base part 21, as with the case of the protector 20.

The leg parts 24B are not provided al an edge of the second surface 21e of the base part 21, but provided on a center side of the edge of the second surface 21e of the base part 21. Such a protector 20B also allows an assembly to (i) be protected from a shake while the assembly packed in a box is being transported and (ii) be easily put in and taken out from the box.

The leg parts 24B are not provided in symmetry with respect to the center of the second surface 21e, but provided at respective positions which are lower than through holes 21b in a case where the protector 20B is placed such that a main surface of the base part 21 is perpendicular to a floor. This causes the leg parts 24B not to block, for example, a worker's hand or a robot arm in a case where the assembly is put in or taken out from the box. It is therefore possible to easily put the assembly in and take the assembly out from the box.

The projections 23B are provided at respective vertices of a first surface 21d. In Embodiment 3, the projections 23B are inclined outward so that an area of a plane formed by respective heads of the projections 23B is greater than that of the base part 21. Therefore, in a case where protectors 20B are stocked up, it is possible to prevent the projections 23B of a lower one of the protectors 20B from blocking the base part 21 of an upper one of the protectors 20B. This allows the protectors 20B not to be bulky even in a case where the protectors 20B are stacked up. Note that the projections 23 of each of the protectors 20 and 20A, which have been described in respective Embodiments 1 and 2, can be configured as the projections 23B.

The protector 20B is similar to the protectors 20 and 20A in that the leg parts 24B have respective heads 24Ba each having a flat surface. Furthermore, the protector 20B is also similar to the protectors 20 and 20A in that the through holes 21b are provided on a center side of the leg parts 24B on the second surface 21e.

### Embodiment 4

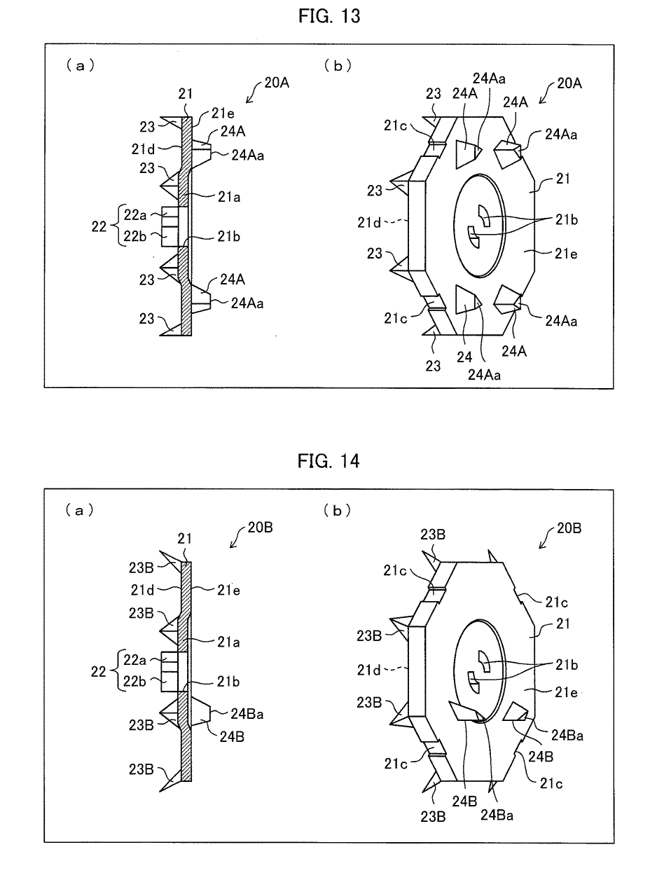

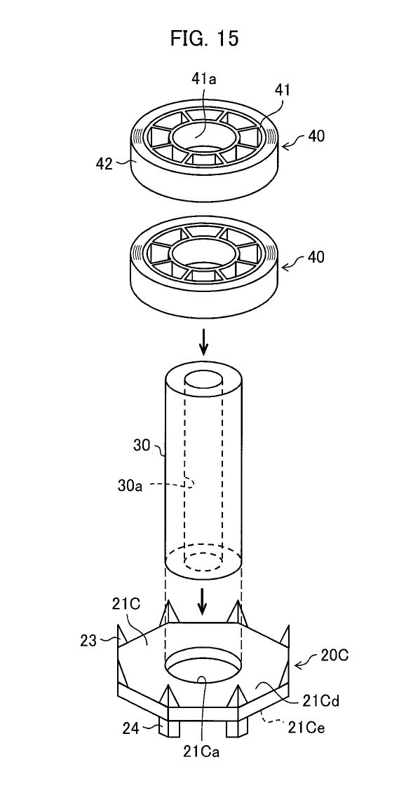

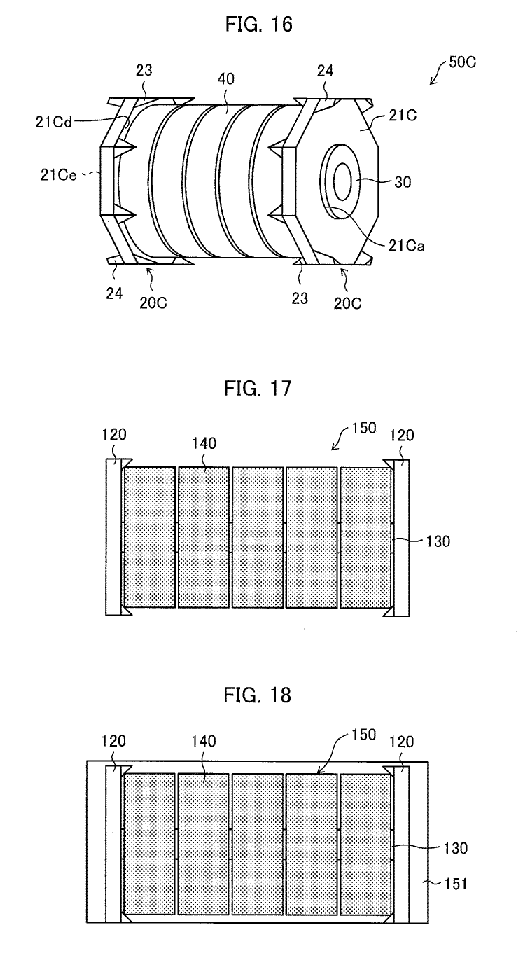

The following description will discuss Embodiment 4 of the present invention with reference to FIGS. 15 and 16. Note that, for convenience of explanation, any member of Embodiment 4 that is identical in function to a corresponding member described for Embodiment 1, 2, or 3 is assigned a common reference numeral, and a description thereof is omitted.

FIG. 15 is a view illustrating how an assembly in accordance with Embodiment 4 of the present invention is assembled. As illustrated in FIG. 15, in Embodiment 4, protectors 20C are used, instead of the protectors 20, 20A, and 20B, to assemble the assembly.

A protector 20C has, at the center of a base part 21C, a through hole 21Ca which extends through the base part 21C from a first surface 21Cd of the base part 21C to a second surface 21Ce of the base part 21C. The through hole 21Ca is so shaped that one of ends of a core member 30 is fitted in the through hole 21Ca.

In an assembly step in accordance with Embodiment 4, the protector 20C is first placed on a horizontal surface, such as a floor, such that the first surface 21Cd faces upward and the second surface 21Ce, which is opposite to the first surface 21Cd and on which leg parts 24 (protrusions) are provided, faces downward.

Then, one of the ends of the core member 30 is fitted into the through hole 21Ca of the protector 20C. This causes the core member 30 to be fitted with the protector 20C at the one of the ends of the core member 30. Note that, in Embodiment 4, the core member 30 does not necessarily have a through hole 30a therein.

Next, a separator roll 40 is placed on the protector 20C such that the other one (that is, an upper end) of the ends of the core member 30 is inserted through an axis hole 41a of the separator roll 40. In this way, the core member 30 is inserted through respective axis holes 41a of separator rolls 40. This causes the separator rolls 40 to be stacked on the protector 20C. Note that a buffer member can be provided between adjacent ones of the separator rolls 40. In this case, the adjacent ones of the separator rolls 40 and the buffer member are alternately stacked up.

After a given number of separator rolls 40 are stacked up, another protector 20C is fitted to the other one of the ends of the core member 30 such that the other one of the ends of the core member 30 is fitted in a through hole 21Ca of the another protector 20C.

FIG. 16 is a view illustrating a configuration of an assembly 50C. The assembly 50C is produced by (i) causing the core member 30 to be Inserted through the given number of separator rolls 40 and (ii) fitting two protectors 20C to the respective ends of the core member 30.

The assembly 50C is then fastened by a fastening band 51 in a fastening step. Thereafter, the core member 30 can be removed from the assembly 50C. This allows the assembly 50C to be produced at a cost lower by a material cost of the core member 30.

Next, in a packing step, the assembly 50C is packed into a box 52 (sec FIG. 9). The assembly 50C can be packed into the box 52 by a worker or a robot.

The packing step involves a robot arm holding or a worker manually holding respective second surfaces 21Ce (outward surfaces) of the two protectors 20C and packing the assembly 50C into the box 52.

Each of the two protectors 20C included in the assembly SOC includes leg parts 24 (protrusions) provided on a corresponding one of the second surfaces 21Ce (outward surface). This allows the assembly 50C to (i) be protected from a shake while the assembly 50C packed in the box 52 is being transported and (ii) be easily put in and taken out from the box 52.

Note that the core member 30 can be fitted with the protectors 20C such that the ends of the core member 30 stick out from the respective second surfaces 21Ce or alternatively do not stick out from the respective second surfaces 21Ce.

As has been described, the core member 30 is positioned on a center side of the leg parts 24, and the core member 30 has therein the through hole 30a. That is, the through hole 30a is positioned on the center side of the leg parts 24. Therefore, in a case where the ends of the core member 30 stick out from the respective second surfaces 21Ce of the protectors 20C, a worker can insert his/her hand or a robot can insert a robot arm into the through hole 30a of the core member 30 so as to put the assembly 50C in the box 52 or take the assembly 50C out from the box 52. This allows the assembly 50C to be put in and taken out from the box 52 stably.

Furthermore, as has been described, the through hole 21Ca is provided on the center side of the leg parts 24 on each of the second surfaces 21Ce. Therefore, in a case where the ends of the core member 30 do not stick out from the respective second surfaces 21Ce of the protectors 20C, a worker can insert his/her hand or a robot can insert a robot arm Into the through hole 21Ca so as to put the assembly 50C in the box 52 or take the assembly 50C out from the box 52. This allows the assembly 50C to be put in and taken out from the box 52 stably.

(Summary)

As has been described, a protector in accordance with an aspect of the present invention is a protector including: a base part having a plate shape, the base part having (i) a first surface which is a main surface and (ii) a second surface which is another main surface and which is opposite to the first surface; a support part provided on the first surface of the base part, the support part being for supporting a core member at one of ends of the core member; and at least one leg part provided on the second surface of the base part, a direction in which the at least one leg part extends being not parallel to the second surface of the base part.

According to the above configuration, the protector includes at least one leg part provided on the second surface of the base part, which second surface is a main surface and which is opposite to the first surface. The at least one leg part protrudes from the second surface. With this configuration, in a case where an assembly is packed in a box, the at least one leg part intervenes between the base part and a side wall of the box. This causes the at least one leg part to absorb a shake that occurs in a direction in which the assembly extends, while the assembly packed in the box is being transported. Therefore, there is no need to put a buffer member or the like between the assembly and the side wall of the box or merely a small amount of a buffer member or the like is needed in a case where the buffer member or the like is put between the assembly and the side wall of the box.

Furthermore, the at least one leg part protrudes so as not to be parallel to the second surface. With this configuration, in a case where a worker uses his/her hand or a robot uses a robot arm to hold the second surface (that is, an outer surface of the assembly) so as to put the assembly in or take the assembly out from the box, the worker can insert his/her hand or the robot can insert the robot arm between leg ports so as to hold a central portion of the second surface. It is therefore possible to prevent the leg parts from blocking the hand or robot arm. This ultimately allows the worker or the robot to easily hold the second surface and thus to easily put the assembly in or take the assembly out from the box. According to the protector, it is thus possible to protect a separator roll from a shake while the separator roll packed in the box is being transported, and thus possible to easily put the assembly in or take the assembly out from the box.

The protector is preferably arranged such that: the at least one leg part includes a plurality of leg parts; and the plurality of leg parts have respective heads which form a plane substantially parallel to the first surface. Note, here, that, in a case where the assembly is vertically placed, that is, placed such that a direction in which the assembly extends is perpendicular to a floor, the respective heads of the plurality of leg parts are in contact with the floor. By arranging the plurality of leg parts such that the heads form a plane substantially parallel to the first surface, it is possible to vertically place the assembly stably.

The protector is preferably arranged such that the at least one leg part has a head which has a flat surface. With this configuration, in a case where the assembly is vertically placed, an area of contact between the plurality of leg parts and the floor is larger, as compared with a case where the respective heads of the plurality of leg parts each have a pointed surface. It is therefore possible to vertically place the assembly more stably.

The protector is preferably arranged such that: the at least one leg part includes a plurality of leg parts; and the plurality of leg parts are provided in symmetry with respect to a center of the second surface. With this configuration, it is possible to vertically place the assembly more stably.

The protector is preferably arranged such that the at least one leg part is provided at an edge of the second surface. According to the above configuration, in a case where the protector is placed on the floor such that the base part is perpendicular to a surface of the floor, the at least one leg part supports the base part. It is therefore possible to cause the protector to stand alone on the floor.

The protector is preferably arranged such that a side surface of the base part and a side surface of the at least one leg part form a flat surface. Since the side surface of the base part and the side surface of the at least one leg part, each of which side surfaces is in contact with the floor, form a flat surface, it is possible to cause the protector to stand alone on the floor more stably.

The protector is preferably arranged such that the base part has a through hole provided so as to, on the second surface, be closer to a center of the base part than the at least one leg part is. With this configuration, it is possible to easily and stably put the assembly in the box and take the assembly out from the box.

The protector is preferably arranged such that the support part protrudes from the first surface. According to the above configuration, by being fitted into one of the ends of the core member, the support part supports the core member. This causes the support part not to easily come off the core member while the assembly is being transported.

The protector is preferably arranged such that the through hole is so shaped that a support part of another protector can be inserted in the through hole. The above configuration allows protectors to be stored in a stacked manner without being bulky.

The protector is preferably arranged such that: the through hole is a through hole extending through the base part from the second surface to the first surface; and the through hole is so shaped that the one of the ends of the core member is fitted in the through hole. The above configuration allows protectors to support the core member.

An assembly in accordance with an aspect of the present invention is an assembly including: two protectors described above; a core member; and a separator roll which includes a core and a battery separator wound around the core and through which the core member is inserted, the two protectors being fitted to respective ends of the core member. According to the above configuration, the at least one leg part of each of the two protectors allows the assembly to (i) be protected from a shake while the assembly packed in the box is being transported and (ii) be easily put in and taken out from the box.

The assembly can be arranged so as to further include a belt-shaped member with which the two protectors and the separator roll are fastened.

The assembly is preferably arranged such that the belt-shaped member is a stretch film. With this configuration, it is possible to easily break the belt-shaped member manually without use of any tool such as scissors. This allows the assembly to be easily disassembled and also allows the separator roll to be easily removed from the core member.

The present invention is not limited to the embodiments, but can be altered by a skilled person in the art within the scope of the claims. An embodiment derived from a proper combination of technical means each disclosed in a different embodiment is also encompassed in the technical scope of the present invention.

### REFERENCE SIGNS LIST

1 Lithium-ion secondary battery

2 External device

3 Lithium ions

4 Heat-resistant layer

5 Porous film

6 Slitting apparatus

7 Cutting device

11 Cathode

12, 42 Separator

13 Anode

20, 20A, 20B, 20C Protector

21, 21C Base part

21a Bulge

21b, 21Ca Through hole

22, 22a, 22b Support part

23, 23B Projection

24, 24A, 24B Leg part

24a, 24Aa, 24Ba Head

25 Opening

30 Core member

30a Through hole

40 Separator roll

41, c, u, 1 Core

41a Axis hole

50, 50C Assembly

51 Fastening band

61 Wind-off roller

62, 63, 66, 67, 68 Roller

70L, 70U Take-up roller

71 Holder

1. A protector comprising:
a base part having a plate shape, the base part having (i) a first surface which is a main surface and (ii) a second surface which is another main surface and which is opposite to the first surface;
a support part provided on the first surface of the base part, the support part being for supporting a core member at one of ends of the core member; and
at least one leg part provided on the second surface of the base part, a direction in which the at least one leg part extends being not parallel to the second surface of the base part.

2. The protector as set forth in claim 1, wherein:
the at least one leg part includes a plurality of leg parts; and
the plurality of leg parts have respective heads which form a plane substantially parallel to the first surface.

3. The protector as set forth in claim 1, wherein the at least one leg part has a head which has a flat surface.

4. The protector as set forth in claim 1, wherein:
the at least one leg part includes a plurality of leg parts; and
the plurality of leg parts are provided in symmetry with respect to a center of the second surface.

5. The protector as set forth in claim 1, wherein the at least one leg part is provided at an edge of the second surface.

6. The protector as set forth in claim 5, wherein a side surface of the base part and a side surface of the at least one leg part form a flat surface.

7. The protector as set forth in claim 1, wherein the base part has a through hole provided so as to, on the second surface, be closer to a center of the base part than the at least one leg part is.

8. The protector as set forth in claim 7, wherein the support part protrudes from the first surface.

9. The protector as set forth in claim, 8, wherein the through hole is so shaped that a support part of another protector can be inserted in the through hole.

10. The protector as set forth in claim 7, wherein:
the through hole is a through hole extending through the base part from the second surface to the first surface; and
the through hole is so shaped that the one of the ends of the core member is fitted in the through hole.

11. An assembly comprising:
two protectors recited in claim 1;
a core member; and
a separator roll which includes a core and a battery separator wound around the core and through which the core member is inserted,
the two protectors being fitted to respective ends of the core member.

12. The assembly as set forth in claim 11, further comprising a belt-shaped member with which the two protectors and the separator roll are fastened.

13. The assembly as set forth in claim 12, wherein the belt-shaped member is a stretch film.
